(19) United States
(12) Patent Application Publication
(10) Pub. No.: US 2017/0154248 A1
(43) Pub. Date: Jun. 1, 2017

(54) Multi-Scale Computer Vision

(71) Applicant: Intel Corporation, Santa Clara, CA (US)

(72) Inventor: Tae-Hoon Kim, Seoul (KR)

(21) Appl. No.: 14/953,748

(22) Filed: Nov. 30, 2015

(51) Int. Cl. G06K 9/66; H04L 29/08; G06F 17/30

(52) U.S. Cl. CPC G06K 9/66; G06F 17/30256; H04L 67/32

(57) ABSTRACT

Attributes of large scale computer vision systems may be made available to users of more limited processor-based systems by dynamically and adaptively updating recognizers into a smaller scale device from a connected larger scale device, based on the user's situational context and behavior. A recognizer is a hardware, software or firmware module specialized to use computer vision to recognize a defined class of imaged objects.

### BACKGROUND

Computer vision involves the use of a computer to identify a perceived object. Computer vision systems may be implemented in mobile devices so that as the user sees an object, it may be identified. Thus, ideally, the computer vision system is mobile and may be associated with a relatively small device such as a cellular telephone, a wearable computer, computer enhanced glasses, to mention a few examples.

However, computer vision addresses various scales. For example, small scale problems may include face detection and ten category recognition. A large scale computer vision problem may be general recognition for one million categories.

Since target devices for computer vision technologies have various levels of computing power and various resources such as processing capability and memory capacity, they can embed various scales of computer vision features.

However, users may expect computer vision features include the capability to handle large scale problems regardless of the resources of their smaller scale devices.

### BRIEF DESCRIPTION OF THE DRAWINGS

Some embodiments are described with respect to the following figures:

FIG. 1 is a depiction of a mobile device used to implement multi-scale computer vision according to one embodiment;

FIG. 2 is a flow chart for the system shown in FIG. 1 according to one embodiment;

FIG. 3 is a flow chart for a locality module for the embodiment shown in FIG. 1;

FIG. 4 is a coherency module for the system shown in FIG. 1 according to one embodiment;

FIG. 5 is a system depiction for one embodiment; and

FIG. 6 is front elevation of a system according to one embodiment.

### DETAILED DESCRIPTION

Attributes of large scale computer vision systems may be made available to users of more limited processor-based systems by dynamically and adaptively updating recognizers into a smaller scale device from a connected larger scale device, based on the user's situational context and behavior. A recognizer is a hardware, software or firmware module specialized to use computer vision to recognize a defined class of imaged objects.

Images may be detected and/or recognized using locality and coherency of target objects. Locality involves the observation that the set of objects that a user sees in a short time frame is sufficient limited that it is possible to predict a compact set of objects that the user will want to recognize in the future in common cases. Coherency involves the proposition that if a user wants to recognize a given object, the user will soon want to recognize its related or nearby objects.

For locality, a system may use a generic recognizer that is self-updated based on what the user sees. For coherency, a small pool of recognizers may be provided that are replaced with those related to the user's queries. This model is connected to the smaller scale and larger scale devices to make a multi-scale system.

With respect to locality, there are observations that a user makes every day which are mostly finite because the user is in a limited range of activities and sees many common or frequently viewed objects. For example, if you look at a plot of photos taken in Rome by tourists on a map, many people are interested in the same or similar objects. If you look at uploaded pictures from users, the objects are often limited to common objects.

For coherency it is assumed that if the user wants to recognize one object, related or nearby objects are likely to be queried soon. This coherency may be spatial, semantic or both. An example of spatial coherency is if a user sees the Tower of Pisa, then the user is likely to query nearby objects or even this object again. Semantic coherency can be explained by an example. If the user queries a person A, then people related to A are likely to be queried very soon. If President Obama is queried, another president or presidential candidate may be queried soon. If Harry Potter, volume 1 is taken, volume 2 or other books in the same category may be taken next. The locality and coherency capabilities can be used to achieve large scale-like object recognition on mobile and wearable systems.

To handle the finite number of objects that a user sees every day, a self-updatable algorithm begins with the most common categories of objects. To handle other objects, a dynamic pool of recognizers may be accessed. For example, the recognizers can be downloaded to the pool that are suitable for the user's situations.

The system may include an internal recognizer for user-specific objects and a pool of recognizers. It may be targeted at small scale hardware and thus is compact and fast with relatively lower power consumption. It can be self-contained to minimize communications with the cloud in some embodiments.

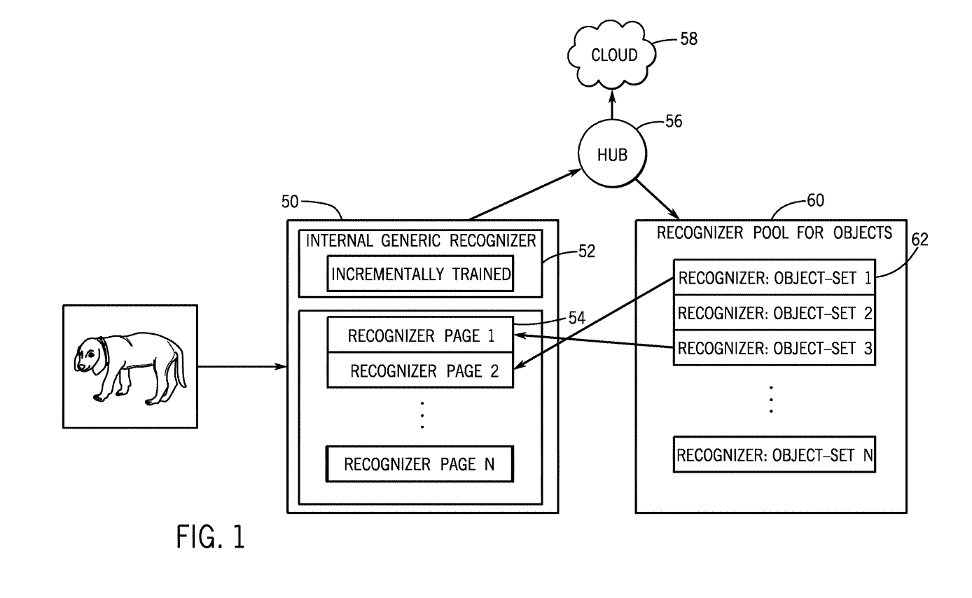

Thus referring to FIG. 1, an image of a dog is queried to the mobile system 50. The mobile system 50 includes an internal generic recognizer 52 that is incrementally trained. By incrementally trained, it is meant that it is trained based on what the user sees and what the user asks the system to do. Thus it uses computer learning to become more useful to the user. In addition, a finite set of recognizers 54 contained in a different memory or in a different portion of memory.

When an image such as the image of the dog in FIG. 1 is queried, it can be recognized by the internal generic recognizer 52 or by the pool of recognizers 54. If recognition in the device fails, a query can be launched to the cloud 58 via a hub 56. If the object is recognized in the cloud, the necessary recognizers are downloaded to the pool as indicated at 60. The pool is a cache of the big pool of recognizers.

One memory 52 may be a fixed size for the internal generic recognizer. It is just a small convolutional neural network (CNN) pre-trained with common objects. It can be updated incrementally as a user uses the system, because the common objects pre-trained are not common for every user.

The other memory 54 has replaceable page slots. It contains multiple small recognizers that try to recognize scenes and objects in parallel. Each recognizer slot can be filled and adaptively replaced by downloading from the cloud server as described above. Then any cache replacement strategies (e.g. least recently used (LRU)) may be used to maintain this pool. Heuristics and spatial semantic coherency may be applied.

The spatial coherency can be achieved in one embodiment by geotagging the images. An image is queried from a system that is at scale S (e.g. a mobile device) and an object at location P is recognized from the image at a system at scale S+ 1 (e.g. a cloud server). The system at scale S+ 1 (server) retrieves a list of recognizers containing objects nearby P, from its local recognizer pool. They are downloaded to the system S to update its recognizer pool. When a pool of the system at S is already full, a replacement strategy, such as a least recently used replacement strategy identifies old recognizers that can be replaced with newly downloaded recognizers.

The semantic coherency may be based on the history of the user's queries by making transitions between all recognizable objects. A model of the semantic coherency can be made using the history of users' queries. If many users' queried an object A after an object B, the coherency from B to A becomes higher. If we consider a map of the coherency between all objects as a graph (of nodes and edges), a coherency from an object to another is a transition between the nodes in the graph.

Based on the probability that an object A is queried after an object B, a list of objects that are likely to be queried after object A is queried can be identified. This may be done based on history for the particular user or by downloading information gleaned from a large number of users for example by downloading from the cloud 58. In other words, the cloud may learn that when people query the Lincoln Memorial, they query the Washington Monument soon thereafter. Thus, the probability, over a large number of users, of what will be queried next can be developed and this information can be used to pre-download recognizers for semantic or locality coherency.

The semantic coherency may be based on the history of the user's queries, from which transitions may be made between all recognizable objects. Based on the probability that an object A is queried after an object B, the list of objects that are likely to be queried next can be identified. Then recognizers corresponding to those objects are downloaded to the system at scale S from that system of scale S+ 1.

Spatial coherency and semantic coherency are not limited to the approach described above. Instead alternative approaches for semantic coherency can be used to predict a future query similar to query recommendations currently done on Google search databases. Other methods to predict a user's behavior can be used. For example, Amazon says ‘users who see this product also like to see these products.’ Many search engines provide ‘related keywords’ for keywords of the user's query. This kind of information can be used for the semantic coherency.

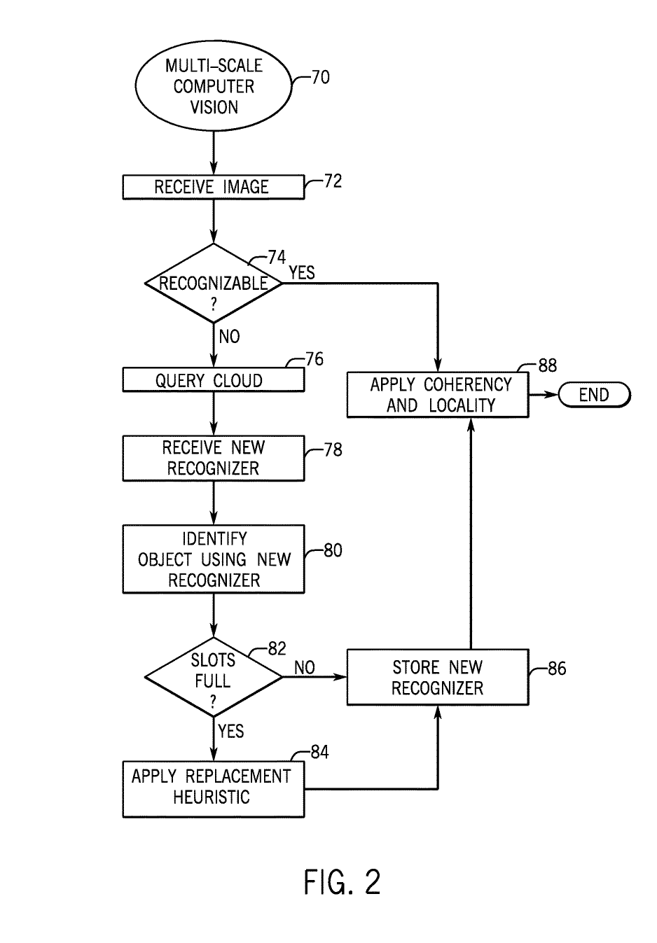

Referring to FIG. 2, a sequence 70 may be implemented in software, firmware and/or hardware. In software and firmware embodiments it may be implemented by computer executed instructions stored in one or more non-transitory computer readable media such as magnetic, optical or semiconductor storage.

The sequence shown in FIG. 2 begins by receiving a new image as indicated in block 72. Images may be received in a lot of ways including an image capturing system such as a camera, glasses, or any computer accessible database. A check at diamond 74 determines whether the image is recognizable using either the internal generic recognizer 52, or the pool of recognizers 54. If so, then coherency and locality modules are applied as indicated at 88.

Otherwise, a remote server or cloud is queried as indicated in block 76. Then a new recognizer may be received from the cloud as indicated in block 78. The received image is then identified using the new recognizer as indicated in block 80. Then a check at diamond 82 determines whether all the fillable slots within the device 50 are full. If so, a slot replace heuristic is applied as indicated in block 84. Then in either case, the new recognizer is stored in a slot as indicated at block 86. Finally, coherency and locality modules are applied as indicated in block 88.

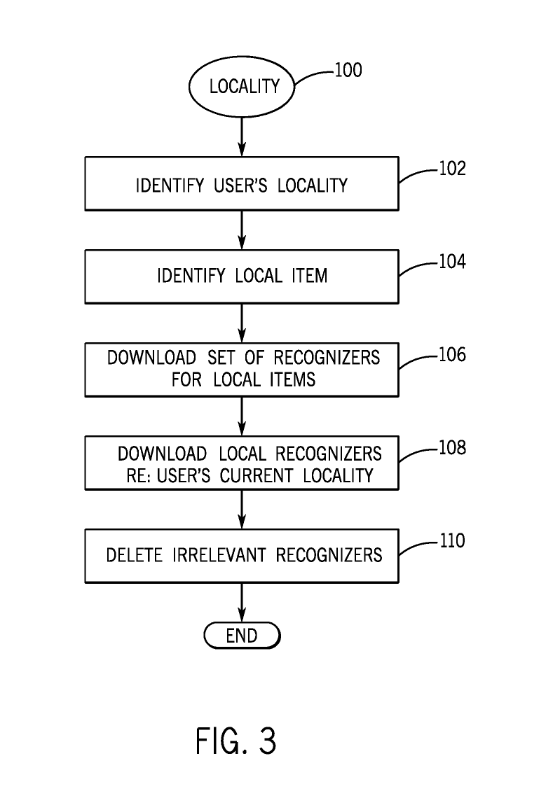

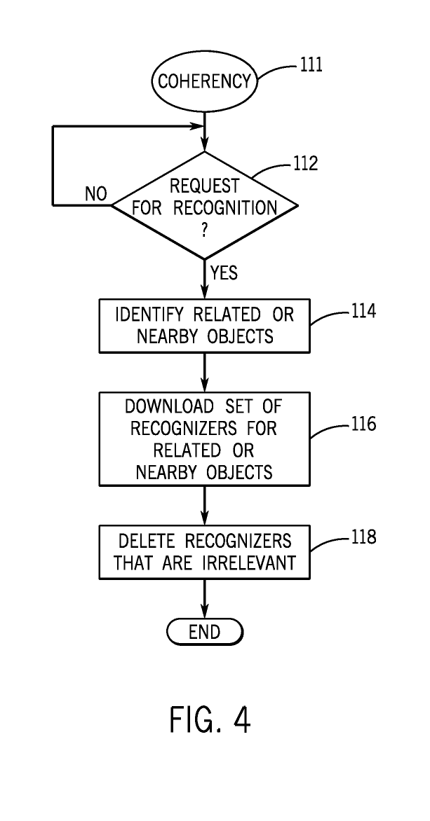

FIGS. 3 and 4 show locality and coherency modules that may be applied in block 88. These two may be implemented in software, firmware and/or hardware. In software and firmware embodiments they may be implemented by computer executed instructions stored in one or more non-transitory computer readable media such as magnetic, optical or semiconductor storage.

The locality module sequence shown in FIG. 3 begins by identifying the user's current location (block 102). This may be done by using a conventional global positioning system (GPS) as one example. It also may be gleaned from geotags associated with images received by the system. Then local items are identified as indicated in block 104. A set of recognizers for each local item may be identified within the system itself or downloaded more likely from the remote server as indicated in block 106. Then the newly downloaded recognizer for the user's current location may be stored as indicated in block 108. A replacement strategy may be used to delete spatially irrelevant recognizers or using some other replacement algorithm (block 110).

In FIG. 4, a coherency module 111 receives a request for recognition as indicated in block 112. Related or nearby objects are then identified as indicated in block 114. This may be done using mapping software, or using information about what other users commonly request in similar circumstances. Then a set of recognizers for related or nearby objects may be downloaded as indicated in block 116. Again, in some cases room may be needed to accept these new recognizers so existing recognizers may be deleted as necessary as indicated in block 118.

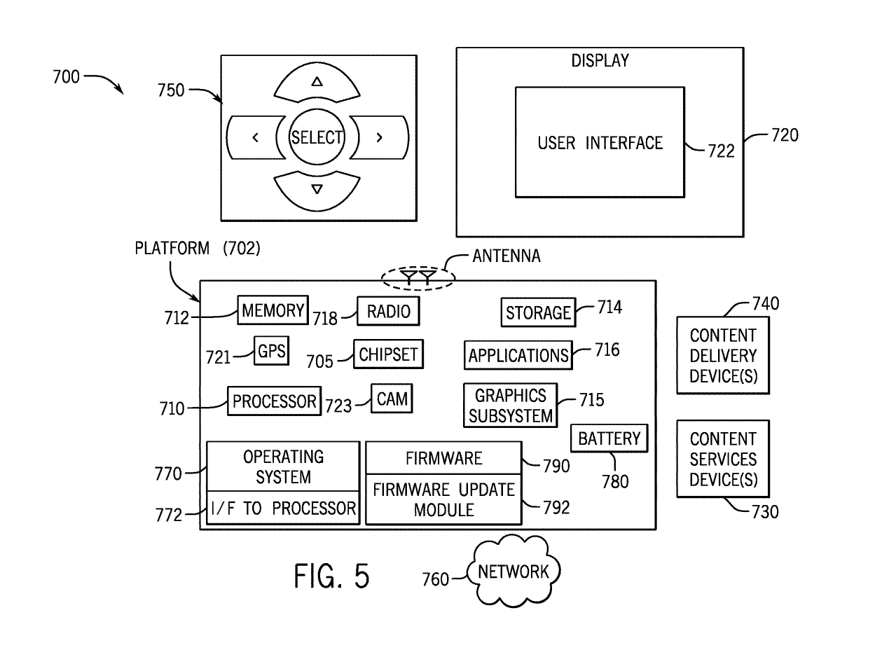

FIG. 5 illustrates an embodiment of a system 700. In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 700 comprises a platform 702 coupled to a display 720. Platform 702 may receive content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, platform 702 may comprise any combination of a chipset 705, processor 710, memory 712, storage 714, graphics subsystem 715, applications 716 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

Processor 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 710 may comprise dual-core processor(s), dual-core mobile processor(s), and so forth. The processor may implement the sequences of FIGS. 2-4 together with memory 712.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, DisplayPort, wireless HDMI, and/or wireless HD compliant techniques. Graphics subsystem 715 could be integrated into processor 710 or chipset 705. Graphics subsystem 715 could be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 718 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In embodiments, display 720 may comprise any television type monitor or display. Display 720 may comprise, for example, a computer display screen, touch screen display, video monitor, television-like device, and/or a television. Display 720 may be digital and/or analog. In embodiments, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In embodiments, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In embodiments, content services device(s) 730 may comprise a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 receives content such as cable television programming including media information, digital information, and/or other content. Examples of content providers may include any cable or satellite television or radio or Internet content providers. The provided examples are not meant to limit the applicable embodiments.

In embodiments, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be echoed on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but integrated into platform 702 and/or display 720. Embodiments, however, are not limited to the elements or in the context shown or described herein.

In embodiments, drivers (not shown) may comprise technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 when the platform is turned “off.” In addition, chip set 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to be scope limiting.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 3.

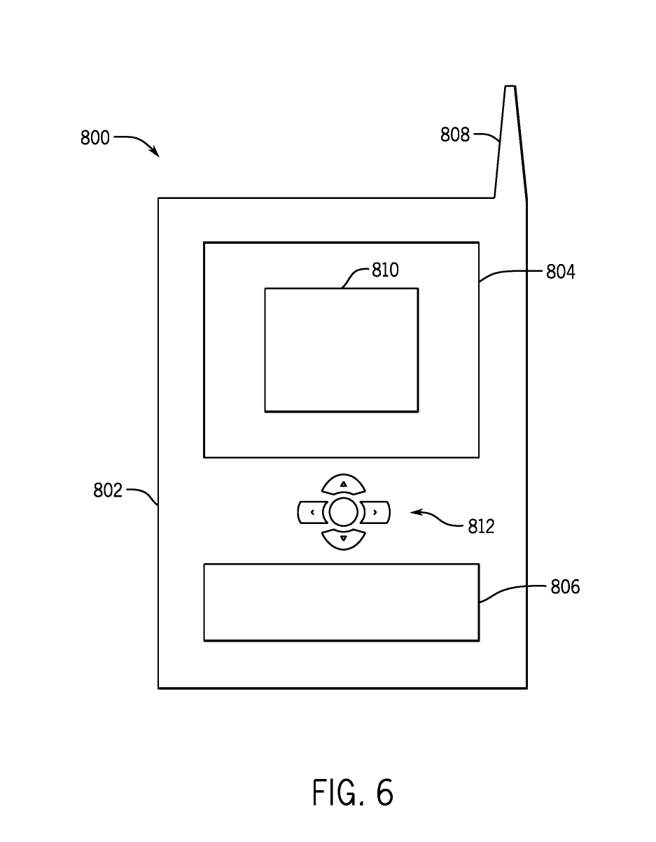

As described above, system 700 may be embodied in varying physical styles or form factors. FIG. 6 illustrates embodiments of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As shown in FIG. 6, device 800 may comprise a housing 802, a display 804 and 810, an input/output (I/O) device 806, and an antenna 808. Device 800 also may comprise navigation features 812. Display 804 may comprise any suitable display unit for displaying information appropriate for a mobile computing device. I/O device 806 may comprise any suitable I/O device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone. Such information may be digitized by a voice recognition device. The embodiments are not limited in this context.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

The following clauses and/or examples pertain to further embodiments:

One example embodiment may be a method comprising receiving an image including an object to be recognized at a first computer vision system, using a location associated with the image to predict another object that the system will be asked to recognize in the future, and predicting still another object that the system will be asked to recognize in the future based on a relationship between the object and the still another object. The method may include maintaining on said system a generic recognizer capable of recognizing a plurality of different objects. The method may include maintaining storage space for downloading a plurality of special use recognizers as needed. The method may include downloading a special use recognizer and storing it in said storage space. The method may include determining whether the object can be recognized on said system and if not, forwarding said image to a remote server. The method may include receiving from said remote server a recognizer for said object. The method may include storing said recognizer from said remote server in said storage space. The method may include accessing a database storing information about objects that are queried after an initial object identification query.

Another example embodiment may include one or more non-transitory computer readable media storing instructions to perform a sequence comprising receiving an image including an object to be recognized at a first computer vision system, using a location associated with the image to predict another object that the system will be asked to recognize in the future, and predicting still another object that the system will be asked to recognize in the future based on a relationship between the object and the still another object. The media may include further storing instructions to perform a sequence including maintaining on said system a generic recognizer capable of recognizing a plurality of different objects. The media may include further storing instructions to perform a sequence including maintaining storage space for downloading a plurality of special use recognizers as needed. The media may include further storing instructions to perform a sequence including downloading a special use recognizer and storing it in said storage space. The media may include further storing instructions to perform a sequence including determining whether the object can be recognized on said system and if not, forwarding said image to a remote server. The media may include further storing instructions to perform a sequence including receiving from said remote server a recognizer for said object. The media may include further storing instructions to perform a sequence including storing said recognizer from said remote server in said storage space. The media may include further storing instructions to perform a sequence including accessing a database storing information about objects that are queried after an initial object identification query.

In another example embodiment may be an apparatus comprising a processor to receive an image including an object to be recognized at a first computer vision system, use a location associated with the image to predict another object that the system will be asked to recognize in the future, predict still another object that the system will be asked to recognize in the future based on a relationship between the object and the still another object, and a memory coupled to said processor. The apparatus may include said processor to maintain on said system a generic recognizer capable of recognizing a plurality of different objects. The apparatus may include said processor to maintain storage space for downloading a plurality of special use recognizers as needed. The apparatus may include said processor to download a special use recognizer and storing it in said storage space. The apparatus may include said processor to determine whether the object can be recognized on said system and if not, forwarding said image to a remote server. The apparatus may include said processor to receive from said remote server a recognizer for said object. The apparatus may include said processor to store said recognizer from said remote server in said storage space. The apparatus may include said processor to access a database storing information about objects that are queried after an initial object identification query. The apparatus may include a display communicatively coupled to the processor. The apparatus may include a battery coupled to the processor.

References throughout this specification to “one embodiment” or “an embodiment” mean that a particular feature, structure, or characteristic described in connection with the embodiment is included in at least one implementation encompassed within the present disclosure. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While a limited number of embodiments have been described, those skilled in the art will appreciate numerous modifications and variations therefrom. It is intended that the appended claims cover all such modifications and variations as fall within the true spirit and scope of this disclosure.

1. A method comprising:
receiving an image including an object to be recognized at a first computer vision system;
using a location associated with the image to enable the system predict another object that the system will be asked to recognize in the future; and
enabling the system to predict still another object that the system will be asked to recognize in the future based on a relationship between the object and the still another object.

2. The method of claim 1 including maintaining on said system a generic recognizer capable of recognizing a plurality of different objects.

3. The method of claim 2 including maintaining storage space for downloading a plurality of special use recognizers as needed.

4. The method of claim 3 including downloading a special use recognizer and storing it in said storage space.

5. The method of claim 4 including determining whether the object can be recognized on said system and if not, forwarding said image to a remote server.

6. The method of claim 5 including receiving from said remote server a recognizer for said object.

7. The method of claim 6 including storing said recognizer from said remote server in said storage space.

8. The method of claim 1 including accessing a database storing information about objects that are queried after an initial object identification query.

9. One or more non-transitory computer readable media storing instructions to perform a sequence comprising:
receiving an image including an object to be recognized at a first computer vision system;
using a location associated with the image to predict another object that the system will be asked to recognize in the future; and
predicting still another object that the system will be asked to recognize in the future based on a relationship between the object and the still another object.

10. The media of claim 9, further storing instructions to perform a sequence including maintaining on said system a generic recognizer capable of recognizing a plurality of different objects.

11. The media of claim 10, further storing instructions to perform a sequence including maintaining storage space for downloading a plurality of special use recognizers as needed.

12. The media of claim 11, further storing instructions to perform a sequence including downloading a special use recognizer and storing it in said storage space.

13. The media of claim 12, further storing instructions to perform a sequence including determining whether the object can be recognized on said system and if not, forwarding said image to a remote server.

14. The media of claim 13, further storing instructions to perform a sequence including receiving from said remote server a recognizer for said object.

15. The media of claim 14, further storing instructions to perform a sequence including storing said recognizer from said remote server in said storage space.

16. The media of claim 9, further storing instructions to perform a sequence including accessing a database storing information about objects that are queried after an initial object identification query.

17. An apparatus comprising:
a processor to receive an image including an object to be recognized at a first computer vision system, use a location associated with the image to predict another object that the system will be asked to recognize in the future, predict still another object that the system will be asked to recognize in the future based on a relationship between the object and the still another object; and
a memory coupled to said processor.

18. The apparatus of claim 17, said processor to maintain on said system a generic recognizer capable of recognizing a plurality of different objects.

19. The apparatus of claim 18, said processor to maintain storage space for downloading a plurality of special use recognizers as needed.

20. The apparatus of claim 19, said processor to download a special use recognizer and storing it in said storage space.

21. The apparatus of claim 20, said processor to determine whether the object can be recognized on said system and if not, forwarding said image to a remote server.

22. The apparatus of claim 21, said processor to receive from said remote server a recognizer for said object.

23. The apparatus of claim 22, said processor to store said recognizer from said remote server in said storage space.

24. The apparatus of claim 17, said processor to access a database storing information about objects that are queried after an initial object identification query.

25. The apparatus of claim 17 including a display communicatively coupled to the processor.

26. The apparatus of claim 17 including a battery coupled to the processor.
